(19) United States
(12) Patent Application Publication
(10) Pub. No.: US 2025/0091023 A1
(43) Pub. Date: Mar. 20, 2025

(54) CONTROL OF A COMMODITY AGITATION SYSTEM

(71) Applicant: DEERE & COMPANY, Moline, IL (US)

(72) Inventors: Brendan M. KUHNS, Colona, IL (US); Luke A. SHATEK, Moline, IL (US); Karson E. SMELTZLY, Port Byron, IL (US)

(73) Assignee: DEERE & COMPANY, Moline, IL (US)

(21) Appl. No.: 18/469,067

(22) Filed: Sep. 18, 2023

(51) Int. Cl. B01F 35/22; A01C 15/00; B01F 27/70; B01F 35/21; B01F 35/213; B01F 35/221

(52) U.S. Cl. CPC B01F 35/2209; A01C 15/007; B01F 27/70; B01F 35/2112; B01F 35/2117; B01F 35/213; B01F 35/221422

(57) ABSTRACT

A commodity agitation system is provided for agitating a commodity in a commodity feed system including a tank storing the commodity and a metering device delivering the commodity to a seeder duct of an associated agricultural implement. An agitator module of the commodity agitation system includes a frame configured to couple the agitator module with the tank, a commodity working member configured to engage the commodity stored in the tank, and a drive system configured to control movement of the commodity working member based on a command signal. A controller of the commodity agitation system includes a memory device, a processor device, a set of agitation control parameters and control logic stored in the memory device. The agitation control logic is executable by the processor device to generate the command signal for controlling the movement of the commodity working member based on the set of agitation control parameters.

### FIELD OF THE DISCLOSURE

The subject disclosure relates to agricultural implements and, in particular, to control of a commodity agitator in a seeder.

### BACKGROUND

Agitation systems have been provided in agricultural implements such as seeders, air carts, and the like for agitation of a commodity as it is delivered from a storage tank to a metering device during use of the implement. These have included various types of working members that extend into the commodity in the storage tank and that are rotated by an electric or hydraulic motor coupled to the agitator member by a gearbox or the like.

In order to make changes to the operation of these agitators to provide better agitation in certain circumstances such as for example for use with different types of commodities, manual mechanical reconfiguration is necessary. Some options for making the manual mechanical reconfiguration in these types of agitation systems include replacing the commodity working members, replacing the gearbox or, at a minimum, replacing the gears within the gearbox.

Another option for making operational changes in these types of agitation systems is to manually replace the working members that extend into the commodity in the storage tank with a members having different commodity engagement profiles.

There is a need therefore for a commodity agitation system that may be controlled by an operator without the requirement of manual repairs.

There is therefore a further for a commodity agitation system that may be automatically controlled by a control system without the requirement of manual repairs.

### SUMMARY

The embodiments herein are directed to commodity agitation systems.

An embodiment herein is directed to control of a commodity agitation system.

An embodiment herein is directed to direct manual control of a commodity agitation system by an operator.

An embodiment herein is directed to automatic control of a commodity agitation system by a controller.

In accordance with an aspect herein, a system is provided for agitating a commodity in a commodity feed system including a tank storing the commodity and a metering device delivering the commodity to a seeder duct of an associated agricultural implement. The system includes an agitator module and a controller. The agitator module includes a frame configured to couple the agitator module with the tank, a commodity working member configured to engage the commodity stored in the tank, and a drive system configured to control movement of the commodity working member based on a command signal. The controller includes a memory device, a processor device operatively coupled with the memory device, a set of agitation control parameters stored in the memory device, and agitation control logic stored in the memory device. In accordance with an aspect herein, the agitation control logic is executable by the processor device to generate the command signal for controlling the movement of the commodity working member based on the set of agitation control parameters.

In any of the embodiments, the set of agitation control parameters may comprise a speed command parameter, and the agitation control logic may be executable by the processor device to generate the command signal to control a speed of movement of the commodity working member based on the speed command parameter.

In any of the embodiments, the speed command parameter may comprise a rotational speed command parameter, and the agitation control logic may be executable by the processor device to generate the command signal to control a rotational speed of movement of the commodity working member based on the rotational speed command parameter.

In any of the embodiments, the set of agitation control parameters may comprise a duty cycle command parameter, and the agitation control logic may be executable by the processor device to generate the command signal to control movement of the commodity working member to a fraction of a repeating period based on the duty cycle command parameter.

In any of the embodiments, the set of agitation control parameters may comprise a movement extent command parameter, and the agitation control logic may be executable by the processor device to generate the command signal to control an extent of movement of the commodity working member based on the movement extent command parameter.

In any of the embodiments, the system may further comprise a human interface device operatively coupled with the controller, the human interface device being configured to receive the set of agitation control parameters from an associated human operator of the system, wherein the set of agitation control parameters comprises one or more of a speed command parameter, a duty cycle command parameter, and/or a movement extent command parameter, and wherein the agitation control logic is executable by the processor device to generate the command signal to control a corresponding one or more of a speed of movement of the commodity working member based on the speed command parameter, movement of the commodity working member to a fraction of a repeating period based on the duty cycle command parameter, and/or an extent of movement of the commodity working member based on the movement extent command parameter.

In any of the embodiments, the system may further comprise a fill height sensor operatively coupled with the controller, the fill height sensor generating a fill height signal representative of a fill level of the commodity in the tank, wherein the agitation control logic is executable by the processor device to generate the command signal for controlling the movement of the commodity working member based on the set of agitation control parameters and the fill height signal.

In any of the embodiments, the system may further comprise a tank load sensor operatively coupled with the controller, the tank load sensor generating a commodity weight signal representative of an amount of the commodity in the tank, wherein the agitation control logic is executable by the processor device to generate the command signal for controlling the movement of the commodity working member based on the set of agitation control parameters and the commodity weight signal.

In any of the embodiments, the system may further comprise a weather condition sensor operatively coupled with the controller, the weather condition sensor generating a weather condition signal representative of a condition of the weather, wherein the agitation control logic is executable by the processor device to generate the command signal for controlling the movement of the commodity working member based on the set of agitation control parameters and the weather condition signal.

In any of the embodiments, the system may further comprise a commodity condition sensor operatively coupled with the controller, the commodity condition sensor generating a commodity condition signal representative of a condition of the commodity stored in the tank, wherein the agitation control logic is executable by the processor device to generate the command signal for controlling the movement of the commodity working member based on the set of agitation control parameters and the commodity condition signal.

In accordance with a further aspect herein, a method is provided for operating an agitator module in a commodity feed system including a tank storing the commodity and a metering device delivering the commodity to a seeder duct of an associated agricultural implement. The method includes providing an agitator module including a frame configured to couple the agitator module with the tank, a commodity working member configured to engage the commodity stored in the tank, and a drive system configured to control movement of the commodity working member based on a command signal. The method further includes providing a controller including a memory device, a processor device operatively coupled with the memory device, a set of agitation control parameters stored in the memory device, and agitation control logic stored in the memory device. The method further includes executing the agitation control logic by a processor device of the controller to generate a command signal for controlling movement of a commodity working member of the agitation module based on the set of agitation control parameters stored in the memory device of the controller.

In accordance with a further aspect herein, a non-transitory computer readable media is provided storing instructions that when executed by a processor device of a controller performs a method for operating an agitator module in a commodity feed system including a tank storing the commodity and a metering device delivering the commodity to a seeder duct of an associated agricultural implement by storing a set of agitation control parameters stored in a memory device of a controller, storing agitation control logic in the memory device of the controller, and executing the agitation control logic by a processor device of the controller to generate a command signal for controlling movement of a commodity working member of the agitation module based on the set of agitation control parameters stored in the memory device of the controller.

In accordance with a further aspect herein, a method is provided for operating an agitator module in a commodity feed system including a tank storing the commodity and a metering device delivering the commodity to a seeder duct of an associated agricultural implement. The method includes storing a set of agitation control parameters stored in a memory device of a controller. The method further includes storing agitation control logic in the memory device of the controller. The method further includes executing the agitation control logic by a processor device of the controller to generate a command signal for controlling movement of a commodity working member of the agitation module based on the set of agitation control parameters stored in the memory device of the controller.

In any of the embodiments herein, the storing the set of agitation control parameters may comprise storing a speed command parameter in the memory device, and the executing the agitation control logic by the processor device may comprise executing the control logic by the processor device to generate the command signal to control a speed of movement of the commodity working member based on the speed command parameter.

In any of the embodiments herein, the storing the speed command parameter may comprise storing a rotational speed command parameter in the memory device, and the executing the agitation control logic by the processor device may comprise executing the control logic by the processor device to generate the command signal to control a rotational speed of movement of the commodity working member based on the rotational speed command parameter.

In any of the embodiments herein, the storing the set of agitation control parameters may comprise storing a duty cycle command parameter in the memory device, and the executing the agitation control logic by the processor device may comprise executing the control logic by the processor device to generate the command signal to control movement of the commodity working member to a fraction of a repeating period based on the duty cycle command parameter.

In any of the embodiments herein, the storing the set of agitation control parameters may comprise storing a movement extent command parameter in the memory device, and the executing the agitation control logic by the processor device may comprise executing the control logic by the processor device to generate the command signal to control an extent of movement of the commodity working member based on the movement extent command parameter.

In any of the embodiments herein, the method may further comprise receiving the set of agitation control parameters from an associated human operator of the system by a human interface device operatively coupled with the controller, wherein the set of agitation control parameters comprises one or more of a speed command parameter, a duty cycle command parameter, and/or a movement extent command parameter, wherein the executing the agitation control logic by the processor device comprises executing the control logic by the processor device to generate the command signal to control a corresponding one or more of a speed of movement of the commodity working member based on the speed command parameter, movement of the commodity working member to a fraction of a repeating period based on the duty cycle command parameter, and/or an extent of movement of the commodity working member based on the movement extent command parameter.

In any of the embodiments herein, the method may further comprise receiving from a fill height sensor operatively coupled with the controller a fill height signal representative of a fill level of the commodity in the tank, wherein the executing the agitation control logic by the processor device comprises executing the control logic by the processor device to generate the command signal for controlling the movement of the commodity working member based on the set of agitation control parameters and the fill height signal.

In any of the embodiments herein, the method may further comprise receiving from a tank load sensor operatively coupled with the controller a commodity weight signal representative of an amount of the commodity in the tank, wherein the executing the agitation control logic by the processor device comprises executing the control logic by the processor device to generate the command signal for controlling the movement of the commodity working member based on the set of agitation control parameters and the commodity weight signal.

In any of the embodiments herein, the method may further comprise receiving from a weather condition sensor operatively coupled with the controller a weather condition signal representative of a condition of the weather, wherein the executing the agitation control logic by the processor device comprises executing the control logic by the processor device to generate the command signal for controlling the movement of the commodity working member based on the set of agitation control parameters and the weather condition signal.

In any of the embodiments herein, the method may further comprise receiving from a commodity condition sensor operatively coupled with the controller a commodity condition signal representative of a condition of the commodity stored in the tank, wherein the executing the agitation control logic by the processor device comprises executing the control logic by the processor device to generate the command signal for controlling the movement of the commodity working member based on the set of agitation control parameters and the commodity condition signal.

### BRIEF DESCRIPTION OF THE DRAWINGS

In the accompanying drawings which are incorporated in and constitute a part of the specification, embodiments of the disclosure are illustrated, which, together with the general descriptions given above, and the detailed description given below, serve to exemplify the embodiments of this disclosure.

FIG. 1 is a side view of a towed cart and prime mover along with an attached implement in accordance with an example embodiment.

FIG. 2A is a block diagram view of a system for agitating a commodity in accordance with an example embodiment.

FIG. 2B is a schematic view of the system for agitating a commodity of FIG. 2A disposed in a commodity feed system in accordance with an example embodiment.

FIG. 3 is a front side view of a portion of a commodity feed system of the type shown in FIG. 2B in accordance with an example embodiment.

FIG. 4 is an elevated perspective view of the agitator module shown in FIG. 3 in accordance with an example implementation.

FIG. 5 is an elevated perspective view of the rotary agitator and drive system shown in FIG. 4 in accordance with an example implementation.

FIG. 6 is a hardware block diagram that illustrates a representative controller apparatus according to the example embodiments.

FIG. 7 is an illustration showing an agitation system control interface image viewable and usable by the operator of the associated tractor or seeder in accordance with an example embodiment.

FIG. 8 is an illustration showing an agitation system status report interface image viewable by the operator of the associated tractor or seeder in accordance with an example embodiment.

FIG. 9 is a flow diagram showing a method of controlling a commodity agitation system in accordance with an example embodiment.

### DETAILED DESCRIPTION

For the purpose of promoting an understanding of the principles of the present disclosure, reference will now be made to the embodiments described herein and illustrated in the drawings and specific language will be used to describe the same. It will nevertheless be understood that no limitation of the scope of the present disclosure is thereby intended, such alterations and further modifications in the illustrated devices and methods, and such further applications of the principles of the present disclosure as illustrated therein being contemplated as would normally occur to one skilled in the art to which the present disclosure relates.

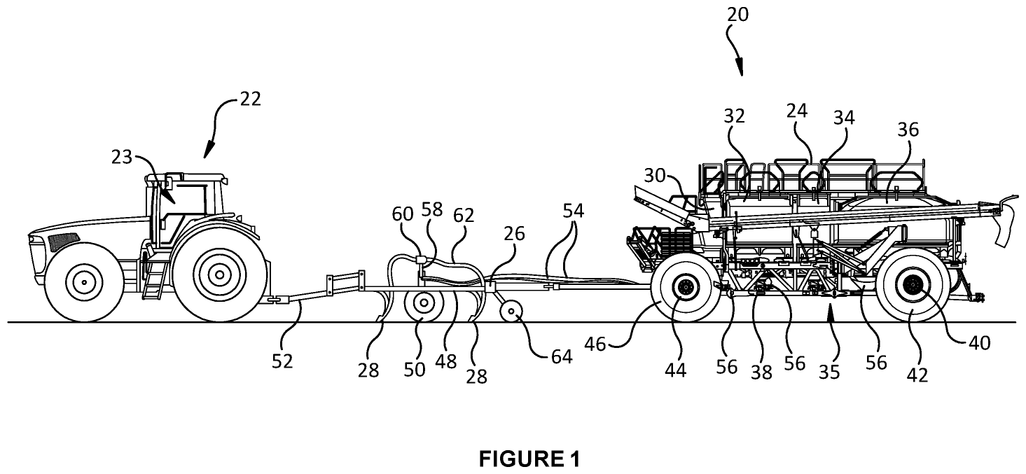

An air or pneumatic seeder 20 is shown in FIG. 1 towed by a tractor or prime mover 22. Seeder 20 includes an air cart 24, also known as a commodity cart, having one or more tanks for one or more commodities to be applied to the soil, and a drill or implement 26 that applies the commodity to the soil. The drill has a plurality of ground engaging tools 28. Cart 24 is shown with four tanks 30, 32, 34, and 36 mounted on a frame 38. Frame 38 is supported on a rear axle 40 having wheels/tires 42 at the rear of the frame 38. Depending on the cart configuration, additional axles may be provided, such as front axle 44 having wheels/tires 46. The axles and wheels support the cart frame 38 for movement over the ground surface towed by tractor 22. Any number of tanks can be provided on the air cart. The term “cart” should be broadly construed to include any device towed by a prime mover that is supported on one or more axles, such as a trailer, wagon, cart, implement, etc.

Drill 26 includes a frame 48 supported by ground wheels 50 and is connected to the rear of the tractor 22 by a tongue 52. As shown, the cart 24 is known as a “tow behind” cart meaning that the cart follows the drill. In alternative arrangements, the cart may be a “tow between” cart meaning that the cart is disposed while in use between the tractor 22 and drill 26. In yet a further possible arrangement, the air cart and drill can be combined onto a common frame. The tanks 30, 32, 34, and 36 can be of any suitable size and/or shape for holding a material or commodity such as seed or fertilizer to be distributed to the soil. The tanks could be hoppers, bins, boxes, containers, etc. The term “tank” shall be broadly construed herein. Furthermore, a single tank with multiple compartments can also be provided.

A pneumatic distribution system 35 includes a fan (not shown) located behind the front tires 46, connected to a product delivery conduit structure having multiple product flow passages 54. The fan directs air through the passages 54. A product meter assembly 56 is located at the bottom of each tank and delivers product from the tanks at a controlled rate to the passages 54 and the air stream moving through the passages 54.

Each passage 54 carries product in the air stream to a secondary distribution tower 58 on the drill 26. Typically, there will be one tower 58 for each passage 54. Each tower 58 includes a secondary distributing manifold 60 located at the top of a vertical tube. The distributing manifold 60 divides the flow of product into several secondary distribution lines 62. Each secondary distribution line 62 delivers product to one of a plurality of ground engaging tools 28 which opens a furrow in the soil and deposits the product therein. The number of passages 54 may vary from one to eight or ten or more, depending on the configuration of the cart and drill. Depending on the cart and drill, there may be two distribution manifolds in the air stream between the meters and the ground engaging tools. Alternatively, in some configurations, the product is metered directly from the tank into secondary distribution lines 62 leading to the ground engaging tools 28 without an intermediate distribution manifold.

A firming or closing wheel 64 associated with each tool 28 trails the tool and firms the soil over the product deposited in the soil. Various types of tools 28 may be used including, tines, shanks, disks, etc. The tools 28 are movable between a lowered position engaging the ground and a raised position above the ground. Each tool may be configured to be raised by a separate actuator. Alternatively, multiple tools 28 may be mounted to a common rockshaft for movement together. In yet another alternative, the tools 28 may be fixed to the frame 38 and the frame 38 raised and lowered by linkages on each of the drill wheels 50.

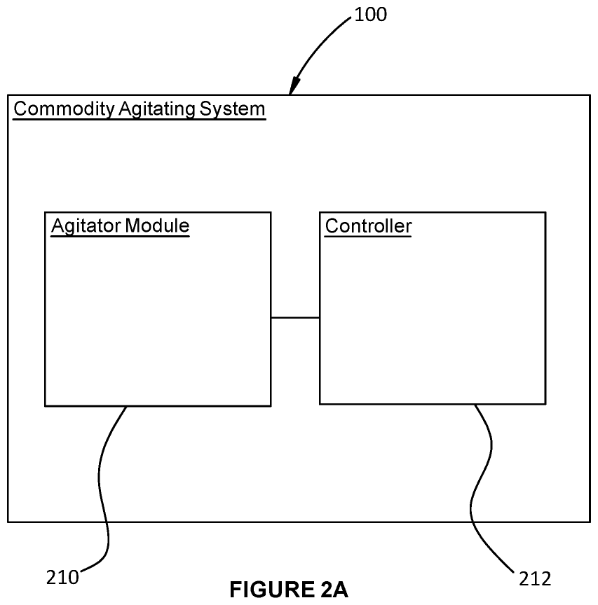

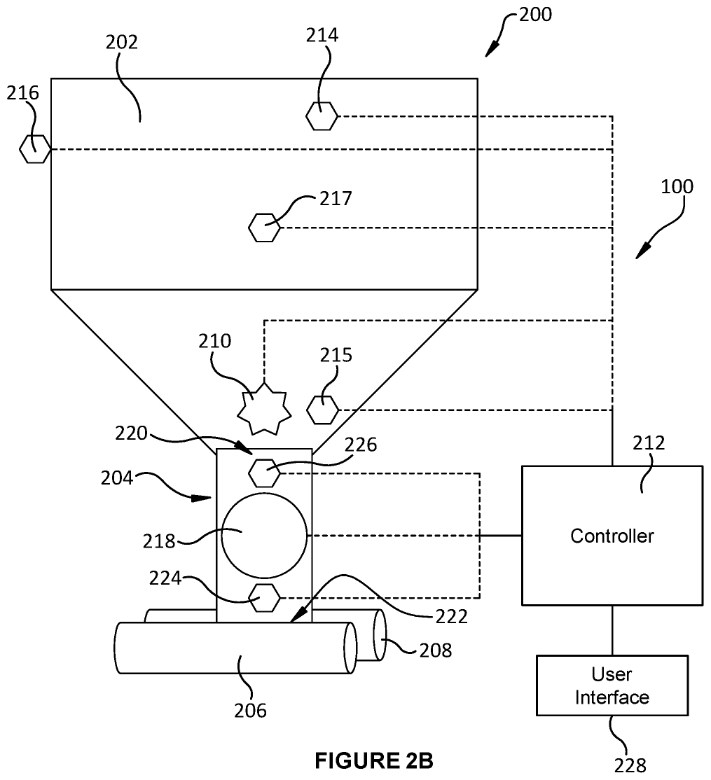

FIG. 2A is a schematic view of a system 100 for agitating a commodity in accordance with an example embodiment As shown, the system 100 includes an agitator module 210 and a controller 212, each of which will be described in greater detail herein.

FIG. 2B is a schematic view of the system 100 for agitating a commodity of FIG. 2A disposed in a commodity feed system in accordance with an example embodiment. As shown, the meter assembly 200 may have a reservoir or tank 202 coupled to a meter 204. The tank 202 may be any of the tanks 30, 32, 34, and/or 36 and be sized to contain commodity therein and direct the commodity to the meter 204. “Commodity” herein may refer to seed, fertilizer, or other nutrients and the like that promote growing a crop. The meter 204 may be representative of the product meter assembly 56. Further, the meter 204 may selectively distribute commodity from the tank 202 to a first or second passage 206, 208. In one aspect of this disclosure, the meter 204 may have a run selector, flapper, or the like that is selectively repositionable to distribute commodity from the tank 202 into either one of the first passage 206 or the second passage 208 depending on the position of the flapper.

While two passages 206, 208 are illustrated herein, this disclosure contemplates embodiments with more than two passages coupled to the meter 204. Further still, there may be only one passage coupled to the meter 204. As will be understood in view of this disclosure, the teachings discussed herein are applicable to meters having any number of passages coupled thereto.

In one aspect of this disclosure, the tank 202 may have an agitator module 210 positioned in or on the tank 202. The agitator module 210 may include one or more working elements or members for engaging the commodity wherein the commodity working members may be a single rotary agitator in accordance with an example having extensions that extend radially away from a rotation axis. The extensions essentially form paddles that stir or mix the commodity as the actuator shaft is rotated. The agitator module 210 may interact with the tank 202 to agitate any commodity therein to ensure the commodity is properly fed into the meter 204. In one aspect of this disclosure, the rotational speed of the rotary agitator of the agitator module 210 may be dictated or otherwise controlled by the controller 212. In a further aspect of this disclosure, the duty cycle of operation of the rotary agitator of the agitator module 210 may be dictated or otherwise controlled by the controller 212. In a still further aspect of this disclosure, the angle of rotation of the rotary agitator of the agitator module 210 may be dictated or otherwise controlled by the controller 212. In a still yet further aspect of this disclosure, one or more of the rotational speed of the rotary agitator of the agitator module 210, the duty cycle of operation of the rotary agitator of the agitator module 210, and/or the angle of rotation of the rotary agitator of the agitator module 210 may be dictated or otherwise controlled by the controller 212. In that way, the operator of the tractor 22 and/or a control system or controller may control the agitator module 210 to properly and efficiently interact with the tank 202 to agitate any commodity therein to ensure the commodity is properly fed into the product flow passages 54, 56 via the meter 204 for various operating conditions of the seeder 20.

As will be described in greater detail below, the commodity working member such as the rotary agitator of the agitator module 210 of the example embodiment may be coupled to a motor or the like for causing the agitator to move relative to the commodity tank. In one non-limiting example the motor is an electrical motor that is controlled by the controller 212 to rotate the rotary agitator of the agitator module 210. However, the motor may be a pneumatic or hydraulic motor as well that is controlled through the controller 212 via a corresponding electro-hydraulic or electro-pneumatic system. The motor may also be an electrical stepper motor. Accordingly, this disclosure contemplates implementing the teachings discussed herein to control the commodity working member such as the rotary agitator of an agitator module 210 with the controller 212 utilizing an electrical, electro-hydraulic, or electro-pneumatic system.

While a rotary agitator is discussed herein, this disclosure contemplates any type of commodity agitator for the agitator module 210 including for example a vibratory agitator module or the like wherein mechanical vibrations are used to agitate any commodity therein to ensure the commodity is properly fed into the product flow passages 54, 56 via the meter 204 for various operating conditions of the seeder 20. In one aspect of this disclosure, the agitator module 210 may be selectively engaged by a controller 212 to agitate any commodity in the tank 202. Other types of commodity agitators for the agitator module 210 including for example reciprocating and/or oscillating agitators or the like wherein mechanical reciprocal and/or oscillatory movements are used to agitate any commodity therein to ensure the commodity is properly fed into the product flow passages.

The amount or presence of commodity in the tank 202 may be identified through one or more sensors as well. In one non-exclusive example, a tank fill height sensor 214 may be positioned to identify the fill height of any commodity in the tank 202. The sensor 214 may be an ultrasonic sensor, a camera, or any other sensor that can identify the presence of commodity in the tank 202. In this configuration, the sensor 214 may communicate readings to the controller 212 that are indicative of the fill height of the commodity in the tank 202. In one aspect of this disclosure, the fill height reading obtained from the sensor 214 inspecting an empty tank 202 may be a value stored in a memory unit of the controller 212 or elsewhere. The reading obtained from the empty tank inspection may be compared to the readings from the sensor 214 obtained during use of the seeder 20 to identify when the tank is empty or near to empty. For example, when the sensor 214 identifies a reading to the controller 212 that is about equal to the reading obtained from the empty tank inspection, the controller 212 may identify that the tank 202 is substantially empty and does not contain a significant amount of commodity. In accordance with an example implementation, the controller 212 is operable to adjust, based on the obtained fill reading from the fill height sensor 214, one or more of the rotational speed of the rotary agitator of the agitator module 210, the duty cycle of operation of the agitator module 210, and/or the angle of rotation of the rotary agitator of the agitator module 210.

In accordance with an example implementation, the controller 212 is operable to stepwise and/or continuously adjust, based on the obtained fill reading from the fill height sensor 214, movement of the commodity working member or actuator including control of one or more of the rotational speed of the rotary agitator of the agitator module 210, the duty cycle of operation of the agitator module 210, and/or the angle of rotation of the rotary agitator of the agitator module 210.

In another non-exclusive example, the tank 202 may have a tank load sensor 215 positioned to identify the weight of the tank 202 along with any commodity positioned therein. The sensor 215 may be a load sensor or the like positioned between the tank 202 and the cart frame 38 or portion thereof to identify the weight of the tank 202 and commodity therein. In this configuration, the sensor 215 may communicate readings to the controller 212 that are indicative of the weight of commodity in the tank 202. In one aspect of this disclosure, the weight of the tank 202 may be a value stored in a memory unit of the controller 212 or elsewhere. The weight of the tank 202 may be compared to the readings from the sensor 215 to identify when the tank is empty. For example, when the sensor 215 identifies a reading to the controller 212 that is about equal to the weight of the tank 202, the controller 212 may identify that the tank 202 is substantially empty and does not contain a significant amount of commodity. In accordance with an example implementation, the controller 212 is operable to adjust, based on the obtained tank weight reading from the tank load sensor 215, one or more of the rotational speed of the rotary agitator of the agitator module 210, the duty cycle of operation of the agitator module 210, and/or the angle of rotation of the rotary agitator of the agitator module 210.

In accordance with an example implementation, the controller 212 is operable to stepwise and/or continuously adjust, based on the obtained tank weight reading from the tank load sensor 215, movement of the commodity working member including control of one or more of the rotational speed of the rotary agitator of the agitator module 210, the duty cycle of operation of the agitator module 210, and/or the angle of rotation of the rotary agitator of the agitator module 210.

In another non-exclusive example, the tank 202 may have a weather condition sensor 216 positioned to identify the weather conditions during use of the seeder 20. It is to be appreciated that the weather condition sensor 216 may be positioned anywhere on the seeder 20 as well as on the tractor 22 as may be necessary or desired. The sensor 216 may be a barometric pressure sensor, a rain sensor, a moisture sensor or the like positioned on the tank 202 or on the cart frame 38 or on any portion of the seeder 20 to identify the weather conditions during operation of the seeder 20. In this configuration, the sensor 216 may communicate readings to the controller 212 that are indicative of the weather conditions. In one aspect of this disclosure, a value representative of a preferred nominal weather condition such as for example a preferred nominal humidity or barometric pressure may be stored in a memory unit of the controller 212 or elsewhere. The stored value may be compared to the readings from the sensor 216 to identify an extent of seeder operation outside of a preferred weather condition range. In accordance with an example implementation, the controller 212 is operable to adjust, based on the obtained weather condition reading from the weather condition sensor 216, one or more of the rotational speed of the rotary agitator of the agitator module 210, the duty cycle of operation of the agitator module 210, and/or the angle of rotation of the rotary agitator of the agitator module 210.

In accordance with an example implementation, the controller 212 is operable to stepwise and/or continuously adjust, based on the obtained weather condition reading from the tank load sensor 216, movement of the commodity working member including control of one or more of the rotational speed of the rotary agitator of the agitator module 210, the duty cycle of operation of the agitator module 210, and/or the angle of rotation of the rotary agitator of the agitator module 210.

In another non-exclusive example, the tank 202 may have a commodity condition sensor 217 positioned to identify a condition of the commodity in the tank 202 during use of the seeder 20. The sensor 217 may be a moisture sensor or the like positioned within the tank 202 identify a moisture content of the commodity. In this configuration, the sensor 217 may communicate readings to the controller 212 that are indicative of the moisture content of the commodity for example. In one aspect of this disclosure, a value representative of a preferred nominal moisture content may be stored in a memory unit of the controller 212 or elsewhere. The stored value may be compared to the readings from the sensor 217 to identify an extent of seeder operation outside of a preferred weather condition range. In accordance with an example implementation, the controller 212 is operable to adjust, based on the obtained commodity moisture content condition reading from the sensor 217, one or more of the rotational speed of the rotary agitator of the agitator module 210, the duty cycle of operation of the agitator module 210, and/or the angle of rotation of the rotary agitator of the agitator module 210.

In accordance with an example implementation, the controller 212 is operable to stepwise and/or continuously adjust, based on the obtained commodity moisture content reading from the sensor 217, movement of the commodity working member including control of one or more of the rotational speed of the rotary agitator of the agitator module 210, the duty cycle of operation of the agitator module 210, and/or the angle of rotation of the rotary agitator of the agitator module 210.

In one aspect of this disclosure, the meter 204 may have a roller 218 positioned therein. The roller 218 may selectively distribute commodity from an inlet 220 to an outlet 222. The roller 218 may rotate about an axis and have a plurality of cavities spaced circumferentially there about. Each of the plurality of circumferential cavities may have a radially distal opening that allows commodity to enter and exit each of the plurality of circumferential cavities as the roller 218 rotates. Accordingly, commodity positioned at the inlet 220 may fall by gravity into one of the circumferential cavities of the roller 218 as it rotates thereby. Next, as that roller circumferential cavity rotates about the axis towards the outlet 222, the commodity may fall out of the circumferential cavity as gravity and radial forces move the commodity towards the outlet 222. Accordingly, the commodity may be distributed in a metered fashion from the inlet 220 to the outlet 222 based on the rotation speed of the roller 218.

It is to be appreciated that, alternatively, the meter 204 may have a roller 218 having a plurality of cavities defined therearound on the side of the roller 218 to similarly transfer commodity from the inlet 220 to the outlet 222. In this configuration, the side cavities on the side of the roller 218 moving from the inlet 220 to the outlet 222 may be at least partially filled with commodity. As the side cavities of the roller 218 pass the outlet 222, any commodity therein is typically dispersed out of the outlet 222. As the roller 218 continues to rotate past the outlet 222, the side cavities moving from the outlet 222 back to the inlet 220 are typically substantially void of commodity. This being the case, the meter 204 processes the commodity with the roller 218 along a commodity flow path as the roller 218 rotates to transfer commodity from the tank 202 to the passages 206, 208.

In one aspect of this disclosure, the rotational speed of the roller 218 may be dictated by the controller 212. More specifically, the roller 218 may be coupled to a motor or the like. In one non-limiting example the motor is an electrical motor that is controlled by the controller 212 to rotate the roller 218. However, the motor may be a pneumatic or hydraulic motor as well that is controlled through the controller 212 via a corresponding electro-hydraulic or electro-pneumatic system. Accordingly, this disclosure contemplates implementing the teachings discussed herein to control a roller 218 with the controller 212 utilizing an electrical, electro-hydraulic, and/or electro-pneumatic system.

In another aspect of this disclosure, the outlet 222 may have an outlet sensor 224 positioned to identify a blockage of commodity in the outlet 222. More specifically, the outlet sensor 224 may be positioned between the roller 218 and the passages 206, 208. The sensor 224 may communicate with the controller 212 to identify when a blockage of commodity is present in the outlet 222. In one aspect of this disclosure, the readings of the sensor 224 may be used to identify the source of a commodity blockage in the seeder 20. More specifically, the sensor 224 may identify when commodity is not passing through the meter 204 to allow the controller 212 to respond as discussed herein.

In accordance with an example implementation, the controller 212 is operable to stepwise and/or continuously adjust, based on the obtained commodity blockage reading from the outlet sensor 224, movement of the commodity working member including control of one or more of the rotational speed of the rotary agitator of the agitator module 210, the duty cycle of operation of the agitator module 210, and/or the angle of rotation of the rotary agitator of the agitator module 210.

In one embodiment of this disclosure, an inlet sensor 226 may be positioned along the inlet 220 of the meter 218. The sensor 226 may communicate with the controller 212 to identify when commodity is not present at the inlet 220. More specifically, when the tank 202 is properly filled with commodity, and that commodity is properly flowing through the inlet 220, the sensor 226 may communicate to the controller 212 that commodity is present. However, when the tank 202 is empty or when the commodity jams above the inlet 220, the sensor 226 may communicate to the controller that there is no commodity present at the inlet 220 and therefore the meter 204 is not distributing commodity into the passages 206, 208.

In accordance with an example implementation, the controller 212 is operable to stepwise and/or continuously adjust, based on the obtained signal from the inlet sensor 226, movement of the commodity working member including control of one or more of the rotational speed of the rotary agitator of the agitator module 210, the duty cycle of operation of the agitator module 210, and/or the angle of rotation of the rotary agitator of the agitator module 210.

The controller 212 may also communicate with a human interface device 228. The human interface device 228 may provide a location for a user to input data or commands to the controller 212 as well as allow the controller 212 to provide an indicator to the user. In one non-exclusive example of this disclosure, the human interface device 228 may be a touch screen device. The touch screen device may have a plurality of user-selectable inputs displayed thereon that allow the user to communicate an input preference to the controller 212. In another embodiment, the human interface device 228 may also include buttons and switches among other things positioned on a dash and selectable by a user. In yet another embodiment, the human interface device 228 may rely on visual or auditory input from the user to indicate user preference.

Similarly, the human interface device 228 may provide an indicator to the user regarding actions and observations of the controller 212. More specifically, the human interface device 228 may be a display that shows icons representing the conditions of the seeder 20 identified by the controller 212 via communication with the sensors 214, 215, 224, 226, agitator 210, and roller 218. In one non-limiting example, the human interface device 228 may show an icon when the roller 218 are being powered. Further, the human interface device 228 may show an icon when the agitator module 210 is engaged or being powered. Further still, the controller 212 may show an icon when blockage is identified by the outlet sensor 224 or when no commodity is identified by the inlet sensor 226 among other things. The indication presented by the human interface device 228 may also be a light that is illuminated, an auditory signal played to the user, haptic feedback that is felt by the user, or any other type of indication that may be observable by a user. Further, in one non-exclusive example the human interface device 228 is a remote device such as a tablet, computer, or smartphone.

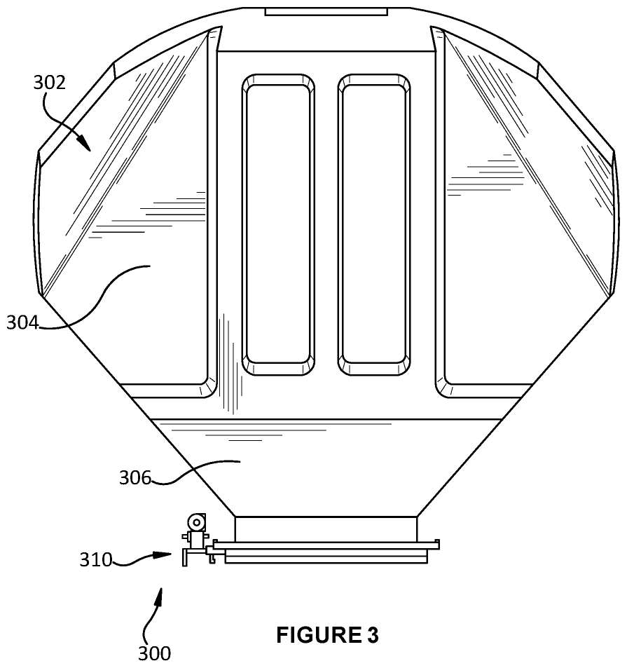

FIG. 3 is a front side view of a portion 300 of a meter assembly of the type described in connection with FIG. 2B. As shown, the portion 300 illustrated essentially includes structure upstream of the meter 204 as represented in FIG. 2B wherein an agitator module 310 is operably coupled with a commodity tank 302. The tank 302 may be any of the tanks 30, 32, 34, and/or 36 illustrated in FIG. 1.

The tank 302 may be sized to contain commodity therein and may be appropriately shaped or otherwise configured to direct the commodity to the meter (not shown) via the agitator module 310. To that end, the tank 302 of the implementation shown in the Figure includes an upper bulk storage portion 304 configured to store large amounts of commodity therein, and a neck portion 306 configured to direct the commodity to a suitable meter (not shown) vis the agitator module 310.

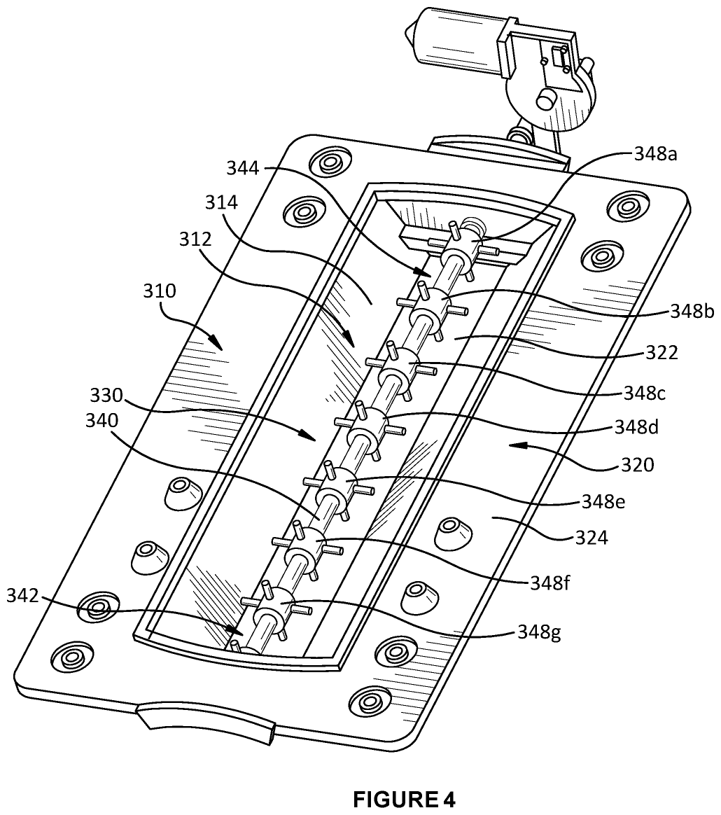

FIG. 4 is an elevated perspective view of the agitator module 310 shown in FIG. 3 in accordance with an example implementation. The agitator module 310 includes a generally rectangular frame member 320 that defines a central opening 322. An upper surface 324 of the frame member 320 is configured to engage a corresponding surface provided on the bottom of the tank 310 (FIG. 3) when the agitator module 310 is coupled with the tank 310.

The frame member 320 provides rotatable support for opposite ends 342, 344 of a commodity working member 330 that in the example implementation is in the form of a single rotary agitator 340. The rotary agitator 340 of the example implementation includes an elongate shaft member 346 that carries a set 348 of commodity mixing elements 348a-348g that are axially spaced apart along the length of the elongate shaft member 346. It is to be appreciated that while a single rotary agitator is discussed herein as an example of a commodity working member 330, this disclosure contemplates any type of commodity agitator for the agitator module 310 including for example a vibratory commodity working member or the like wherein mechanical vibrations are used to agitate any commodity therein to ensure the commodity is properly fed from the tank 302 and into the product flow passages 206, 208 (FIG. 2B) via the meter 204 (FIG. 2B) for various operating conditions of the seeder 20 (FIG. 1). It is further to be appreciated that while a single rotary agitator is discussed herein as an example of a commodity working member 330, this disclosure contemplates any type of plural commodity agitators for the agitator module 310 including for example plural rotating, reciprocating, oscillating, and/or vibrating commodity working members or the like wherein mechanical vibrations are used to agitate any commodity therein to ensure that the commodity is properly fed from the tank and into the product flow passages via the meter for various operating conditions of the seeder. In one aspect of this disclosure, the agitator module 310 may be selectively engaged by a controller 212 to agitate any commodity in the tank 202.

The frame member 320 also provides support in the central opening 322 thereof for a collar member 312 having sloped surfaces 314 that are angled with respect to a flow of the commodity through the agitator module 310 to neck or otherwise concentrate the flow of the commodity towards the elongate shaft member 346 and set of commodity mixing elements 348a-348g in order to best help effect a smooth flow of the commodity through the agitator module 310 without clumping and without other undesirable effects such as damage to the commodity, commodity degradation, agglomerating into chunks or the like.

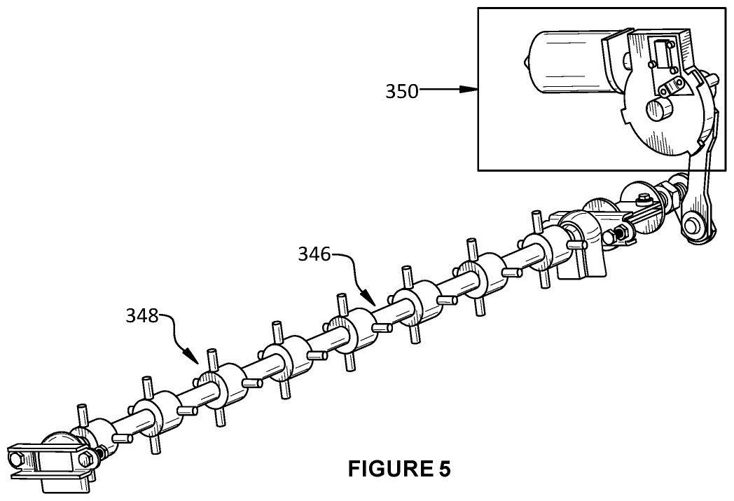

With continued reference to FIG. 4 and with additional reference to FIG. 5, one end of the elongate shaft member 346 of the rotary agitator 340 in the example implementation of a commodity working member 330 extends through the frame member 320 and is coupled with an agitator drive system 350 that in the example implementation effects movement of the elongate shaft member 346 in accordance with command signals received from the controller 212 as will be described in greater detail herein.

In the example implementation, the agitator drive system 350 includes an electric motor 360 coupled with the elongate shaft member 346 of the rotary agitator 340 by a linkage system 370 that essentially converts rotary motion of an output of the electric motor 360 to oscillating rotary in the elongate shaft member 346. To that end, the linkage system 370 includes a crank arm 372 pivotally attached to the end of the elongate shaft member 346 and an intermediate arm 374 pivotally attached on one end with the crank arm 372 and pivotally attached on the other end with a rotary output drive member 376 of the electric motor 360. In the example implementation the agitator drive system 350 is responsive to signals from the controller 212 to cause the commodity working member 330 in the form of a rotary agitator 340 in the example to move relative to the frame member 320 thereby stirring or mixing the commodity as the actuator is moved.

In accordance with an example implementation, the controller 212 is operable to stepwise and/or continuously adjust, based on one or more signals including signals received from an operator of the seeder 20 and/or the tractor 22, movement of the elongate shaft member 346 of the rotary agitator 340 in the example implementation of a commodity working member 330 including control of one or more of the rotational speed of the elongate shaft member 346, and/or the duty cycle of operation of the elongate shaft member 346.

In a further example implementation, the linkage system 370 is replaced with a direct connection between the electric motor 360 and the elongate shaft member 346 of the rotary agitator 340 whereby the controller 212 is operable to stepwise and/or continuously adjust, based on one or more signals including signals received from an operator of the seeder 20 and/or the tractor 22, full rotational movement of the elongate shaft member 346 of the rotary agitator 340 including control of one or more of the rotational speed of the elongate shaft member 346, and/or the duty cycle of operation of the elongate shaft member 346.

In yet a further example implementation, the linkage system 370 is replaced with a direct connection between the electric motor 360 and the elongate shaft member 346 of the rotary agitator 340 and the electric motor is selected as a stepper electric motor whereby the controller 212 is operable to stepwise and/or continuously adjust, based on one or more signals including signals received from an operator of the seeder 20 and/or the tractor 22, full rotational movement of the elongate shaft member 346 of the rotary agitator 340 including control of one or more of the rotational speed of the elongate shaft member 346, the duty cycle of operation of the elongate shaft member 346, and/or the angle of rotation of the rotary agitator of the agitator module 210.

In one non-limiting example the motor is an electrical motor that is controlled by the controller 212 to rotate the rotary agitator of the agitator module 310. However, the motor may be a pneumatic or hydraulic motor as well that is controlled through the controller 212 via a corresponding electro-hydraulic or electro-pneumatic system. The motor may also be an electrical stepper motor. Accordingly, this disclosure contemplates implementing the teachings discussed herein to control the rotary agitator of an agitator module 310 with the controller 212 utilizing an electrical, electro-hydraulic, or electro-pneumatic system.

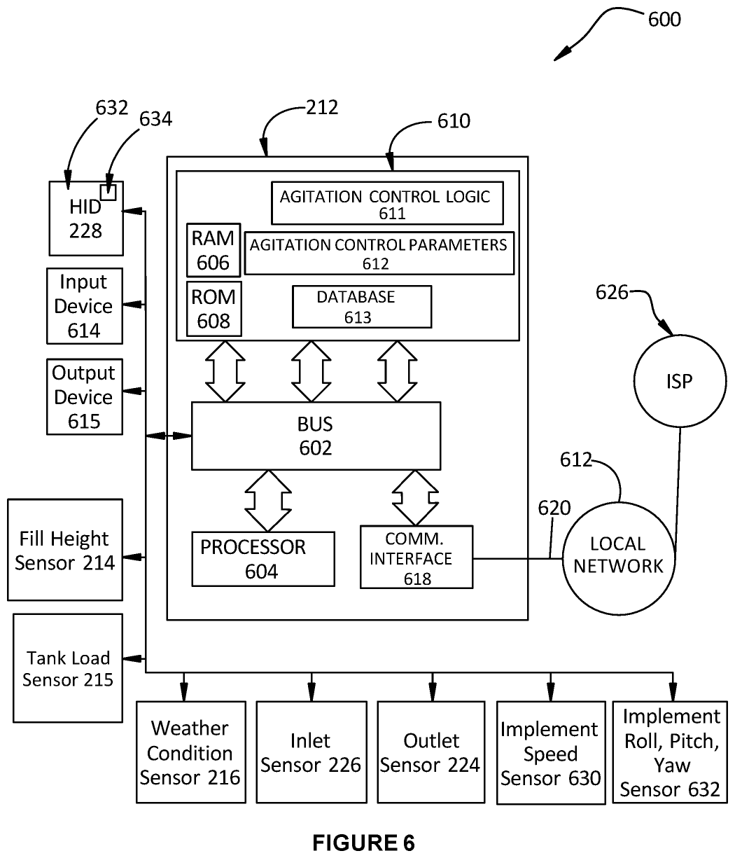

FIG. 6 is a block diagram that illustrates a control system 600 according to the example embodiments. The representative control system 600 according to the example embodiments comprises a controller 212 that includes a bus 602 or other communication mechanism for communicating information, and a processor device 604 coupled with the bus for processing information. The controller 212 further includes a main non-transitory memory device 610 that may comprise one or more memory portions or components or collection of other devices such as random access memory (RAM) 606 or other dynamic storage device for storing information and instructions to be executed by the processor device 604, and read only memory (ROM) 608 or other static storage device for storing static information and instructions for the processor device 604. The memory device 610 is also suitably provided for storing agitation control logic 611 comprising instructions for execution by the processor device, and other information including for example data and instructions for execution by the processor device for obtaining and displaying loader images and messages on the screen 632 of the human interface device 228 that is viewable from an operator's seat of the associated work vehicle 22. The controller 212 of the control system 600 is suitable for executing embodiments of one or more software systems or logic modules that perform a method of controlling the movement of the commodity working member 330 for agitating a commodity in a commodity feed system including a tank storing the commodity and a metering device delivering the commodity to a seeder duct of an associated agricultural implement.

The memory device 610 may further store a set of agitation control parameters 612 stored in the memory device, wherein the agitation control logic 611 is executable by the processor device to generate the command signal for controlling the movement of the commodity working member based on the set of agitation control parameters 612.

The example embodiments described herein are related to the apparatus or controller 212 performing a method of controlling an agitation module to control movement of a commodity working member configured to engage the commodity stored in the tank for agitating the commodity such as for example to best help effect a smooth flow of the commodity through the agitator module without clumping and without other undesirable effects such as damage to the commodity, commodity degradation, agglomerating into chunks or the like.

According to one implementation, control of the movement of the commodity working member is provided by the apparatus or controller 212 in response to the processor device 604 executing the agitation control logic 611 comprising one or more sequences of instructions of logic modules contained in main memory 606. Such instructions may be read into main memory 606 from another computer-readable medium, such as storage device 610. Execution of the sequences of the agitation control logic 611 instructions contained in storage device 610 and/or main memory 606 causes the processor device 604 to perform the process steps described herein. In an alternative implementation, hard-wired circuitry may be used in place of or in combination with software instructions to implement the example embodiments. Thus, implementations of the example embodiments are not limited to any specific combination of hardware circuitry, software, logic, or combinations of hardware, software, and/or logic.

In accordance with the descriptions herein, the term “computer-readable medium” as used herein refers to any non-transitory media that participates in providing agitation control logic 611 instructions to the processor device 204 for execution. Such a non-transitory medium may take many forms, including but not limited to volatile and non-volatile media. Non-volatile media includes, for example, optical or magnetic disks. Volatile media includes dynamic memory for example and does not include transitory signals, carrier waves, or the like. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible non-transitory medium from which a computer can read. The terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In addition, and further in accordance with the descriptions herein, the term “logic”, as used herein with respect to the Figures, includes hardware, firmware, software in execution on a machine, and/or combinations of each to perform a function(s) or an action(s), and/or to cause a function or action from another logic, method, and/or system. Logic may include a software controlled microprocessor device, a discrete logic (e.g., ASIC), an analog circuit, a digital circuit, a programmed logic device, a memory device containing instructions, and so on. Logic may include one or more gates, combinations of gates, or other circuit components.

The commodity agitation control apparatus or controller 600 further includes a communication interface 618 coupled with the bus 602 which provides a two-way data communication coupling to a network link 620 that is connected to local network 612 such as for example a local network of the work vehicle 20 and/or seeder 22 such as a Controller Area Network (CAN) bus or the like. The communication interface 618 may be a controller area network (CAN) card to provide a data communication connection to a compatible CAN bus. As another example, communication interface 618 may be a local area network (LAN) card to provide a data communication connection to a compatible LAN. For example, communication interface 618 may be an integrated services digital network (ISDN) card or a modem to provide a data communication connection to a corresponding type of telephone line. Wireless links may also be implemented. In any such implementation, communication interface 618 may be a wireless receiver/transmitter, i.e. a transceiver operable to send and receive electrical, electromagnetic, radio frequency (RF), and/or optical signals that carry data streams such as digital data streams representing various types of information.

Network link 620 typically provides data communication through one or more networks to other data devices. For example, network link 620 may provide a connection through a local network to a diagnostic host computer (not shown) of the like for supporting configuration of the system as desired or necessary. An Internet Service Provider (ISP) 626 may provide data communication services indirectly through the Internet via the network 612 or directly through the network link 620.

The example commodity agitation control apparatus or controller 600 can send messages and receive data, including program code, through the network(s), network link 620 and communication interface 618. In an Internet-connected example embodiment, the commodity agitation control apparatus or controller 600 is operatively connected with a plurality of external public, private, governmental or commercial servers (not shown) configured to execute a web application in accordance with example embodiments. The example commodity agitation control apparatus or controller 600 suitably includes several subsystems or modules to perform the virtual operator's guidance as set forth herein. One benefit of the subject application is to provide the operator with information regarding the status of the operation of the commodity working member and to provide control of movement of the commodity working member by the operator. A further benefit of the subject application is to provide automated and/or semi-automated control of the operation of the commodity working member based on a set of agitation control parameters that are stored in the memory device and also based on various signals received from the seeder 22 and/or form the tractor 20 relating for example to seeder ground speed, the type of commodity, rate of application, weather conditions, implement width, tank level, roll/pitch/yaw, tank scale/level commodity readings, blockage system information, acoustic sensor information, etc. This allows for improvement in the system performance with respect to commodity flow, commodity degradation, part performance/durability. Beneficially, a novel aspect of this disclosure is in an example implementation the control of the agitation system in real time, with high precision, based on multiple system inputs.

An operator input device 614 may be used to receive a query signal from the operator of the associated seeder 20 or tractor 22 for querying the apparatus 212 to display messages related to the functioning of the agitator module 310, to the level of commodity in the tanks, or the like.

An operator output device 615 may also be provided such as in the form of a sound generating device such as a speaker to help improve commodity and meter assembly monitoring by generating audible warnings, alerts, and/or instructions in the form of audible instructions and/or suitable instructional noises such as beeps, voice messages or the like that can be heard from an operator's seat of the associated work vehicle for helping the operator to be alerted to loader maintenance alert data that might be generated.

The memory device 610 includes a database 613 storing a plurality of sets of predetermined values. In this regard and as discussed above, in one aspect of this disclosure, the fill height reading obtained from the sensor 214 inspecting an empty tank 202 may be a value stored in the database 613 of the controller 212 or elsewhere. In a further aspect of this disclosure, the weight of the tank 202 may be a value stored in the database 613 of the controller 212 or elsewhere. The weight of the tank 202 may be compared to the readings from the sensor 215 to identify when the tank is empty. In a still further aspect of this disclosure, a value representative of a preferred nominal weather condition such as for example a preferred nominal humidity or barometric pressure may be stored in the database 613 of the controller 212 or elsewhere. The stored value may be compared to the readings from the sensor 216 to identify an extent of seeder operation outside of a preferred weather condition range. In a yet still further aspect of this disclosure, a value representative of a preferred nominal moisture content may be stored in the database 613 of the controller 212 or elsewhere. The stored value may be compared to the readings from the sensor 217 to identify an extent of seeder operation outside of a preferred weather condition range.

In addition to the above, the controller apparatus 212 is operatively coupled with a set of sensors including for example the fill height sensor 214, the tank load sensor 215, the weather condition sensor 216, and inlet sensor 226, the outlet sensor 224, an implement ground speed sensor 630 that generates a signal representative of a speed of travel of the seeder 20 relative to the ground during use of the implement, and an implement roll/pitch/yaw sensor 632 that generates a signal representative of a levelness of the implement.

In a further example embodiment, operation environment condition signals representative of an operation environment condition of the seeder 20 may be received by other means and/or in other ways. For example, the operator input device 228 that may include a touchscreen portion 634 of the display unit 632, a pointer device operatively coupled with the monitoring control apparatus 212, or any other device or means of communicating training and other information to the monitoring control apparatus 212 may be used by the system to receive from the operator the operation environment condition signal representative of the operation environment condition of the seeder 20. In that way, the system may receive operation environment condition signals from the operator that might not be easily deduced or otherwise interpreted by traditional physical sensors. By way of example, the system may receive from the operator via the operator input device 634 operation environment condition signal comprising environmental condition data representative of a particular type of commodity being used for each of the tanks 30, 32, 34, and/or 36.

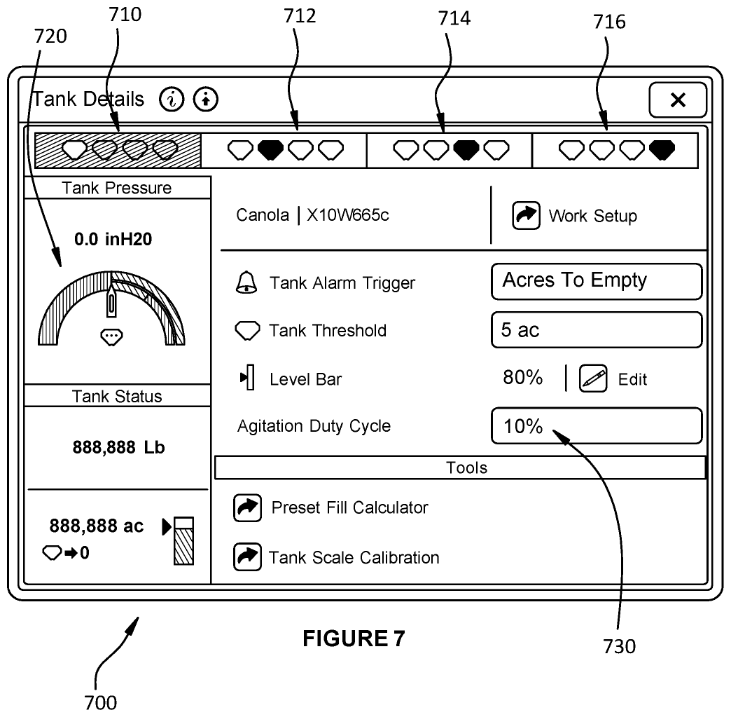

FIG. 7 is an illustration showing an agitation system control interface image 700 viewable and usable by the operator of the associated tractor or seeder in accordance with an example embodiment. With reference now to that Figure, a set of selectable icons 710-716 is useable by the operator on the touchscreen portion 634 of the display unit 632 to select interfacing with agitation controls for one of the commodity tanks 30, 32, 34, or 36. A selection such as by touching the touchscreen portion 634 of the display unit 632 by the operator of the first selectable icon 710 results in the processor device executing the control logic to display the image 700 shown in the Figure. A tank pressure status indicia 720 for the first commodity tank 30 is as shown. In addition, the operator may enter an agitation control parameter value into the text box 730. As shown, the operator has entered “10%” as the desired duty cycle for operating the agitator module 310. Accordingly, the agitation control logic of the subject system is executable by the processor device to generate a command signal for controlling the movement of the commodity working member based on the set of agitation control parameters including the operator-selected “10%” as the desired duty cycle for operating the agitator module 310.

In accordance with the example embodiment, therefore, the agitation control logic is executable by the processor device to generate the command signal for controlling the movement of the commodity working member based on the set of agitation control parameters, and the operator may enter into the system a duty cycle command parameter (10% in the example), and the agitation control logic is executable by the processor device to generate the command signal to control movement of the commodity working member to a fraction of a repeating period based on the duty cycle command parameter.

The operator may similarly enter other agitation parameters such as for example a speed command parameter (not shown), a rotational speed command parameter (not shown), and/or a movement extent parameter (not shown). In accordance with an example embodiment, the agitation control logic is executable by the processor device to generate the command signal to control a speed of movement of the commodity working member based on the speed command parameter selected by the operator using an alternative page (not shown) of the interface 700.

In accordance with a further example embodiment, the agitation control logic is executable by the processor device to generate the command signal to control a rotational speed of movement of the commodity working member based on the rotational speed command parameter selected by the operator using an alternative page (not shown) of the interface 700.

In accordance with a still further example embodiment, the agitation control logic is executable by the processor device to generate the command signal to control an extent of movement of the commodity working member based on the movement extent command parameter selected by the operator using an alternative page (not shown) of the interface 700.

In addition to direct manual operator control of one or more of the duty cycle, the rotational speed and/or the movement extent of the agitation module including the commodity working member as described above, the agitation control logic is executable by the processor device to automatically generate the command signal for controlling the movement of the commodity working member based on the set of agitation control parameters. In this regard, a fill height sensor 214 is provided. The fill height sensor 214 is operatively coupled with the controller and generates a fill height signal representative of a fill level of the commodity in the tank. The agitation control logic is executable by the processor device to automatically generate the command signal for controlling the movement of the commodity working member based on the set of agitation control parameters and the fill height signal.

Further in this regard, a tank load sensor 215 is provided. The tank load sensor 215 is operatively coupled with the controller and generates a commodity weight signal representative of an amount of the commodity in the tank. The agitation control logic is executable by the processor device to automatically generate the command signal for controlling the movement of the commodity working member based on the set of agitation control parameters and the commodity weight signal.

Still further in this regard, a weather condition sensor 216 is provided. The weather condition sensor 216 is operatively coupled with the controller and generates a weather condition signal representative of a condition of the weather. The agitation control logic is executable by the processor device to automatically generate the command signal for controlling the movement of the commodity working member based on the set of agitation control parameters and the weather condition signal.

Yet still further in this regard, a commodity condition sensor 217 is provided. The commodity condition sensor 217 is operatively coupled with the controller and generates a commodity condition signal representative of a condition of the commodity stored in the tank. The agitation control logic is executable by the processor device to automatically generate the command signal for controlling the movement of the commodity working member based on the set of agitation control parameters and the commodity condition signal.

Yet still further in this regard, an inlet sensor 226, an outlet sensor 224, an implement speed sensor 630, and an implement roll/pitch/yaw sensor 632 are provided. These sensors are operatively coupled with the controller generates signals representative of conditions of various parts of the seeder 20. The agitation control logic is executable by the processor device to automatically generate the command signal for controlling the movement of the commodity working member based on the set of agitation control parameters and the signals returned from the inlet sensor 226, the outlet sensor 224, the implement speed sensor 630, and the implement roll/pitch/yaw sensor 632.

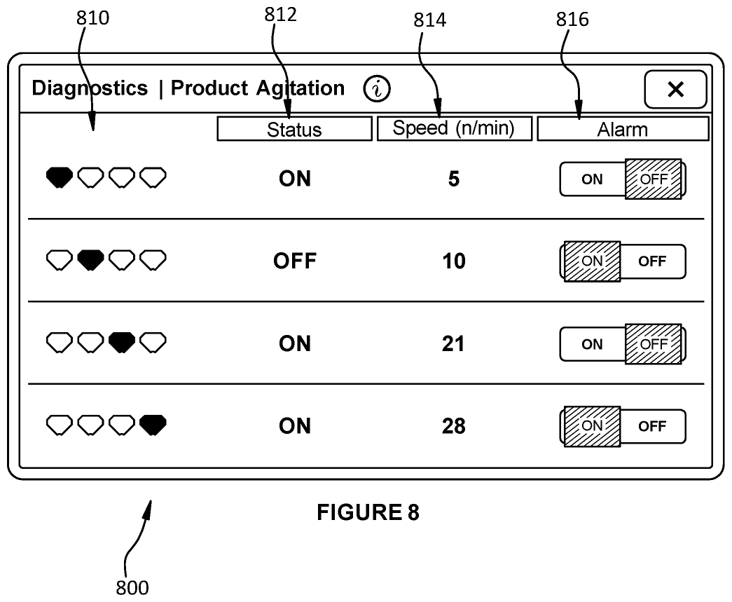

FIG. 8 is an illustration showing an agitation system status report interface image 800 viewable by the operator of the associated tractor 22 or seeder 20 in accordance with an example embodiment. A column 810 of commodity tank icons are presented on the screen to the operator and are indicative of one of the commodity tanks 30, 32, 34, and 36. A further column 812 presents indica of a status of the operation of the commodity working members 330 of each of the commodity tanks 30, 32, 34, and 36 wherein, as illustrated in the example, the commodity working member of the first commodity tank 30 is “ON.” That is, the commodity working member of the first commodity tank 30 is operating. Similarly, as illustrated in the example, the commodity working member of the second commodity tank 32 is “OFF,” the commodity working member of the third commodity tank 34 is “ON,” and commodity working member of the fourth commodity tank 36 is “ON.”

With continued reference to FIG. 8, a still further column 812 presents indica of a status of a commanded speed of operation of the commodity working members 330 of each of the commodity tanks 30, 32, 34, and 36 wherein, as illustrated in the example, the commanded speed of operation of the commodity working member of the first commodity tank 30 is “5 RPM.” That is, the commodity working member of the first commodity tank 30 is commanded to operate at 5 RPM. Similarly, as illustrated in the example, the commanded speed of operation of the commodity working member of the second commodity tank 32 is “10 RPM,” the commanded speed of operation of the commodity working member of the third commodity tank 34 is “21 RPM,” and commanded speed of operation of the commodity working member of the fourth commodity tank 36 is “28 RPM.”

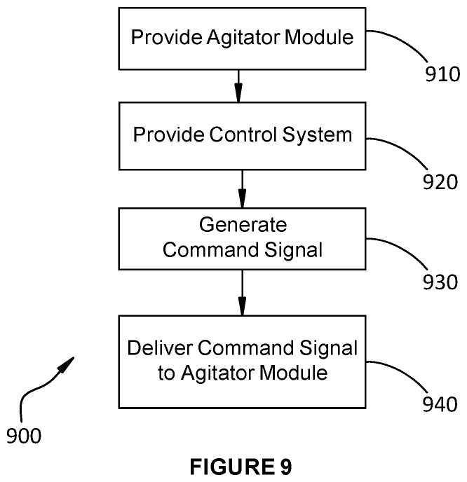

FIG. 9 is a flow diagram showing a method 900 of controlling a commodity agitation system in accordance with an example embodiment. With reference now to that Figure, a method 900 is provided for operating an agitator module in a commodity feed system including a tank storing the commodity and a metering device delivering the commodity to a seeder duct of an associated agricultural implement. The method includes providing an agitator module at 910, wherein the agitator module includes a frame configured to couple the agitator module with the tank, a commodity working member configured to engage the commodity stored in the tank, and a drive system configured to control movement of the commodity working member based on a command signal.

The method 900 further includes providing a controller at 920, wherein the controller includes a memory device, a processor device operatively coupled with the memory device, a set of agitation control parameters stored in the memory device, and agitation control logic stored in the memory device.

The method 900 further includes executing the agitation control logic by a processor device of the controller at 930 to generate a command signal for controlling movement of a commodity working member of the agitation module based on the set of agitation control parameters stored in the memory device of the controller.

The method 900 further includes delivering the control signal to the agitator module to effect the control of the movement of the commodity working member of the agitation module based on the set of agitation control parameters stored in the memory device of the controller.

It is to be understood that other embodiments will be utilized and structural and functional changes will be made without departing from the scope of the claims. The foregoing descriptions of embodiments have been presented for the purposes of illustration and description. It is not intended to be exhaustive or to limit the embodiments to the precise forms disclosed. Accordingly, many modifications and variations are possible in light of the above teachings. It is therefore intended that the scope of the claims not be limited by this detailed description.

1. A system for agitating a commodity in a commodity feed system including a tank storing the commodity and a metering device delivering the commodity to a seeder duct of an associated agricultural implement, the system comprising:
an agitator module comprising:
a frame configured to couple the agitator module with the tank;
a commodity working member configured to engage the commodity stored in the tank; and
a drive system configured to control movement of the commodity working member based on a command signal;
a controller comprising:
a memory device;
a processor device operatively coupled with the memory device;
a set of agitation control parameters stored in the memory device; and
agitation control logic stored in the memory device,
wherein the agitation control logic is executable by the processor device to generate the command signal for controlling the movement of the commodity working member based on the set of agitation control parameters.

2. The system according to claim 1, wherein:
the set of agitation control parameters comprises a speed command parameter; and
the agitation control logic is executable by the processor device to generate the command signal to control a speed of movement of the commodity working member based on the speed command parameter.

3. The system according to claim 2, wherein:
the speed command parameter comprises a rotational speed command parameter; and
the agitation control logic is executable by the processor device to generate the command signal to control a rotational speed of movement of the commodity working member based on the rotational speed command parameter.

4. The system according to claim 1, wherein:
the set of agitation control parameters comprises a duty cycle command parameter; and
the agitation control logic is executable by the processor device to generate the command signal to control movement of the commodity working member to a fraction of a repeating period based on the duty cycle command parameter.

5. The system according to claim 1, wherein:
the set of agitation control parameters comprises a movement extent command parameter; and
the agitation control logic is executable by the processor device to generate the command signal to control an extent of movement of the commodity working member based on the movement extent command parameter.

6. The system according to claim 1, further comprising:
a human interface device operatively coupled with the controller, the human interface device being configured to receive the set of agitation control parameters from an associated human operator of the system,
wherein the set of agitation control parameters comprises one or more of a speed command parameter, a duty cycle command parameter, and/or a movement extent command parameter,
wherein the agitation control logic is executable by the processor device to generate the command signal to control a corresponding one or more of a speed of movement of the commodity working member based on the speed command parameter, movement of the commodity working member to a fraction of a repeating period based on the duty cycle command parameter, and/or an extent of movement of the commodity working member based on the movement extent command parameter.

7. The system according to claim 1, further comprising:
a fill height sensor operatively coupled with the controller, the fill height sensor generating a fill height signal representative of a fill level of the commodity in the tank,
wherein the agitation control logic is executable by the processor device to generate the command signal for controlling the movement of the commodity working member based on the set of agitation control parameters and the fill height signal.

8. The system according to claim 1, further comprising:
a tank load sensor operatively coupled with the controller, the tank load sensor generating a commodity weight signal representative of an amount of the commodity in the tank,
wherein the agitation control logic is executable by the processor device to generate the command signal for controlling the movement of the commodity working member based on the set of agitation control parameters and the commodity weight signal.

9. The system according to claim 1, further comprising:
a weather condition sensor operatively coupled with the controller, the weather condition sensor generating a weather condition signal representative of a condition of the weather,
wherein the agitation control logic is executable by the processor device to generate the command signal for controlling the movement of the commodity working member based on the set of agitation control parameters and the weather condition signal.

10. The system according to claim 1, further comprising:
a commodity condition sensor operatively coupled with the controller, the commodity condition sensor generating a commodity condition signal representative of a condition of the commodity stored in the tank,
wherein the agitation control logic is executable by the processor device to generate the command signal for controlling the movement of the commodity working member based on the set of agitation control parameters and the commodity condition signal.

11. A method of operating an agitator module in a commodity feed system including a tank storing the commodity and a metering device delivering the commodity to a seeder duct of an associated agricultural implement, the method comprising:
storing a set of agitation control parameters stored in a memory device of a controller;
storing agitation control logic in the memory device of the controller;
executing the agitation control logic by a processor device of the controller to generate a command signal for controlling movement of a commodity working member of the agitation module based on the set of agitation control parameters stored in the memory device of the controller.

12. The method according to claim 11, wherein:
the storing the set of agitation control parameters comprises storing a speed command parameter in the memory device; and
the executing the agitation control logic by the processor device comprises executing the control logic by the processor device to generate the command signal to control a speed of movement of the commodity working member based on the speed command parameter.

13. The method according to claim 12, wherein:
the storing the speed command parameter comprises storing a rotational speed command parameter in the memory device; and
the executing the agitation control logic by the processor device comprises executing the control logic by the processor device to generate the command signal to control a rotational speed of movement of the commodity working member based on the rotational speed command parameter.

14. The method according to claim 11, wherein:
the storing the set of agitation control parameters comprises storing a duty cycle command parameter in the memory device; and
the executing the agitation control logic by the processor device comprises executing the control logic by the processor device to generate the command signal to control movement of the commodity working member to a fraction of a repeating period based on the duty cycle command parameter.

15. The method according to claim 11, wherein:
the storing the set of agitation control parameters comprises storing a movement extent command parameter in the memory device; and
the executing the agitation control logic by the processor device comprises executing the control logic by the processor device to generate the command signal to control an extent of movement of the commodity working member based on the movement extent command parameter.

16. The method according to claim 11, further comprising:
receiving the set of agitation control parameters from an associated human operator of the system by a human interface device operatively coupled with the controller, wherein the set of agitation control parameters comprises one or more of a speed command parameter, a duty cycle command parameter, and/or a movement extent command parameter,
wherein the executing the agitation control logic by the processor device comprises executing the control logic by the processor device to generate the command signal to control a corresponding one or more of a speed of movement of the commodity working member based on the speed command parameter, movement of the commodity working member to a fraction of a repeating period based on the duty cycle command parameter, and/or an extent of movement of the commodity working member based on the movement extent command parameter.

17. The method according to claim 11, further comprising:
receiving from a fill height sensor operatively coupled with the controller a fill height signal representative of a fill level of the commodity in the tank,
wherein the executing the agitation control logic by the processor device comprises executing the control logic by the processor device to generate the command signal for controlling the movement of the commodity working member based on the set of agitation control parameters and the fill height signal.

18. The method according to claim 11, further comprising:
receiving from a tank load sensor operatively coupled with the controller a commodity weight signal representative of an amount of the commodity in the tank,
wherein the executing the agitation control logic by the processor device comprises executing the control logic by the processor device to generate the command signal for controlling the movement of the commodity working member based on the set of agitation control parameters and the commodity weight signal.

19. The method according to claim 11, further comprising:
receiving from a weather condition sensor operatively coupled with the controller a weather condition signal representative of a condition of the weather,
wherein the executing the agitation control logic by the processor device comprises executing the control logic by the processor device to generate the command signal for controlling the movement of the commodity working member based on the set of agitation control parameters and the weather condition signal.

20. The method according to claim 11, further comprising:
receiving from a commodity condition sensor operatively coupled with the controller a commodity condition signal representative of a condition of the commodity stored in the tank,
wherein the executing the agitation control logic by the processor device comprises executing the control logic by the processor device to generate the command signal for controlling the movement of the commodity working member based on the set of agitation control parameters and the commodity condition signal.
